(19) United States
(12) Patent Application Publication
(10) Pub. No.: US 2016/0092954 A1
(43) Pub. Date: Mar. 31, 2016

(54) MOBILE DEVICE LOCATION-ENABLED SERVICE PROVISIONING

(71) Applicants: Daniel Bassett, Atlanta, GA (US); Greg Scott Egan, Flowery Branch, GA (US); Gregory James Sirmans, Cumming, GA (US); Curtis Evans, Atlanta, GA (US); Matthew Phillip Kamp, Cumming, GA (US); Brian Plattenburg, Atlanta, GA (US)

(72) Inventors: Daniel Bassett, Atlanta, GA (US); Greg Scott Egan, Flowery Branch, GA (US); Gregory James Sirmans, Cumming, GA (US); Curtis Evans, Atlanta, GA (US); Matthew Phillip Kamp, Cumming, GA (US); Brian Plattenburg, Atlanta, GA (US)

(21) Appl. No.: 14/500,124

(22) Filed: Sep. 29, 2014

(51) Int. Cl. G06Q 30/06; H04W 4/04; H04B 5/00

(52) U.S. Cl. CPC G06Q 30/0613; H04B 5/0062; H04W 4/04

(57) ABSTRACT

Various embodiments each include at least one of systems, devices, methods, and software for mobile device location-enabled service provisioning. One embodiment, in the form of a method, includes receiving, via a network from a mobile device, data including a customer account identifier and an identifier of at least one beacon device. The method then determines, based on the received data, a location of a customer of the customer account identifier relative to each beacon device for which a beacon device identifier is included in the received data. The method then identifies any activities to be initiated with regard to the customer based on a stored customer profile associated with the customer account identifier, the determined location, and at least one activity rule. The method may then execute instructions associated with each identified activity.

### BACKGROUND INFORMATION

Providing service to customers generally requires that the customer location be known. However, this can be difficult in certain establishments, such as those that are large or poorly illuminated. Further, it is common in many businesses for a small percentage of customers to be the most profitable. Identification of these customers and providing them service is therefore a goal. To provide these most profitable customers service, their locations are also needed. Previous efforts have included the use of customer identification cards that may be read by devices, such as card readers, radio frequency identification (RFID) readers of RFID chips embedded in the cards, and the like. However, cards are often not carried, may rely on the customer to present their card, and deployment of additional networked devices to read the cards at many locations.

### SUMMARY

Various embodiments herein each include at least one of systems, devices, methods, and software for mobile device location-enabled service provisioning. Some identify locations of customers via their mobile devices to enable provisioning of services directly to the customers.

One embodiment, in the form of a method, includes receiving, via a network from a mobile device, data including a customer account identifier and an identifier of at least one beacon device. The method then determines, based on the received data, a location of a customer of the customer account identifier relative to each beacon device for which a beacon device identifier is included in the received data. The method then identifies any activities to be initiated with regard to the customer based on a stored customer profile associated with the customer account identifier, the determined location, and at least one activity rule. The method may then execute instructions associated with each identified activity.

Another method embodiment includes receiving a beacon identifier and a customer account identifier via a network from a mobile device. This method then identifies and invokes any data processing activities to be initiated with regard to the customer associated with the customer account identifier at a location at or near a location associated with the beacon identifier.

Some further embodiments are in the form of a system. The system of such embodiments includes at least one network interface device, at least one processor, at least one memory, and an instruction set, stored in memory and executable by the at least one processor to perform data processing activities. The data processing activities may include receiving a beacon identifier and a customer account identifier via the at least one network interface device from a mobile device. The data processing activities further include identifying and invoking any additional data processing activities to be initiated with regard to the customer associated with the customer account identifier at a location at or near a location associated with the beacon identifier.

### BRIEF DESCRIPTION OF THE DRAWINGS

FIG. 1 is a logical block diagram of a system, according to an example embodiment.

FIG. 2 is a block flow diagram of a method, according to an example embodiment.

FIG. 3 is a block flow diagram of a method, according to an example embodiment.

FIG. 4 is a block diagram of a computing device, according to an example embodiment.

### DETAILED DESCRIPTION

Various embodiments herein each include at least one of systems, devices, methods, and software for mobile device location-enabled service provisioning. Some identify locations of customers via their mobile devices to enable provisioning of services directly to the customers. For example, a customer carrying a mobile device has an app deployed thereon. As many, if not most, people in today's society almost always have their mobile device, such as at least one of a smartphone, smartwatch, tablet, and the like, with them at all times, the communication and data processing capabilities of mobile devices are leveraged to identify and locate customers at various locations and times. The mobile device app in such embodiments may receive location related data. The location related data may be received or sourced from a global positioning system (GPS) device of the mobile device, data from a radio signal carrying data encoded therein that may be received by one or more transceiver devices (e.g., BLUETOOTH ®, WI-FI®, mobile carrier network radio device, etc.) of the mobile device, a network accessible service, and the like. The mobile device app may assemble this location data and customer account identifying data and transmit both, via a data network such as the Internet, to a system of an entity providing the app. The entity providing the app may be an operator or manager of restaurant, hotel, casino, airline, retail outlet, among other entities.

The data transmitted to the backend system may then be processed by the backend system to associate the customer with a location and determine whether data processing activities defined and configured in the backend system should be initiated. Such data processing activities are essentially limitless and in most embodiments are bounded only by the creativity of system administrators. For example the data processing activities may include transmitting data or messages to personnel at a reception desk to indicate a customer having a highest loyalty status is approaching and they should be greeted by name. Another data processing activity may transmit data to a mobile device of a sales clerk including a picture of the customer, the customer's name, previous shopping history, and data representing certain preferences of the customer that may be utilized in making product or service recommendations. In some embodiments, the data processing activities may automatically check the customer into a hotel, salon, clinic, and the like. These and other embodiments are described herein with reference to the figures.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

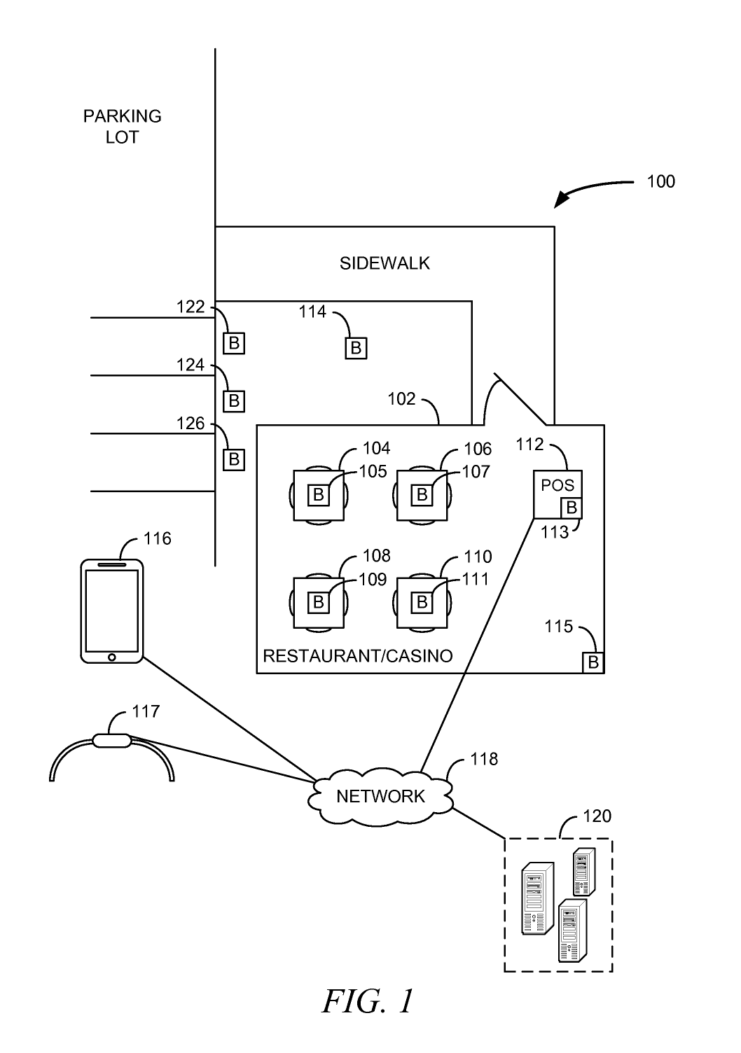

FIG. 1 is a logical block diagram of a system 100, according to an example embodiment. The system 100 is illustrated as deployed with regard to a facility 102, such as a restaurant or casino, although other embodiments may be deployed to other facility types, such as hotel, airport terminals, hospitals and clinics, retail outlets, among others. The system 100 operates to associate a customer account maintained in a backend computing system 120 with a with a customer carrying a mobile device 116, 117 having an app of an operator of the facility 102 or other entity providing app and customer services to an operator of the facility 102.

In an example embodiment, a customer carrying a mobile device 116, 117, such as a smartphone, smartwatch, or tablet, enters the facility 102. The customer mobile device 116, 117 typically includes a mobile device app that executes thereon that allows the customer to perform various actions, such as one or more of creating an account, adding and modifying payment account information, viewing receipts of visits or interactions in the facility 102 or other facilities or access points (e.g., websites, kiosks, etc.), viewing a current bill, viewing a facility 102 map, viewing data of appointments and reservations, and the like. The mobile device 116, 117 app, in some embodiments, receives data received by a transceiver device present on the mobile device 116, 117, such as one or both of a BLUETOOTH® device and a WI-FI® device. In some embodiments, the data may also or alternatively be received via a GPS device of the mobile device 116, 117. An example of data that may be received by the mobile device 116, 117 app is data from one or more beacon devices 105, 107, 109, 111, 113, 114, 115 deployed in and around the facility 102. The data from the one or more beacon devices 105, 107, 109, 111, 113, 114, 115 typically includes identifiers of the respective beacon devices that enable the mobile device 116, 117 app or a backend system 120 service to determine a location of the mobile device. The mobile device 116, 117, and the app thereon, may receive data from one of the beacon devices 105, 107, 109, 111, 113, 114, 115 or a plurality of beacon devices 105, 107, 109, 111, 113, 114, 115.

In an example embodiment, the beacon devices 105, 107, 109, 111, 113, 114, 115 broadcast a radio signal encoded with identifying data that is registered in the backend system 120 with a known location, such as a point of sale (POS) terminal 112, a table 104, 106, 108, 110, a particular gaming machine or table 104, 106, 108, 110 in a casino, a door of a hotel room, a particular hospital waiting room, or other location in the particular facility 102. The beacon device, in some embodiments, may include a radio transceiver device, such as a BLUETOOTH® beacon device. Among others, such beacon devices are available from NCR Corporation of Duluth, Ga. The positioning beacon device may also, or alternatively, include a WI-FI® Wireless Access Point (WAP) device in some embodiments. The radio signal, or signals, broadcast by the beacon device are received by the mobile device 116, 117 and the mobile device 116, 117 app or the backend system 120 may then determine a location of the mobile device 116, 117 based on one or more of the received signals. The position may also be determined based in part on a signal strength of each of the one or more signals received by the mobile device 116, 117.

In some embodiments, the mobile device 116, 117 app, upon receipt of positioning data, such as from one or more of the beacon devices 105, 107, 109, 111, 113, 114, 115 assembles and sends a data message to the backend system 120 including the position data, such as one or more received beacon device identifiers and an identifier of the customer account. The data may be sent, via a network 118 such as the Internet, to the backend system 120 by calling a web service offered by the backend system 120 or sending a another type of data message or method call depending on the particular embodiment.

The backend system 120 may then associate the received web service or other data message or method call with a customer account based on the customer account identifier. The backend system 120 may also then determine a location of the customer based on the one or more beacon device 105, 107, 109, 111, 113, 114, 115 identifiers. Based on the identified customer account and location, one or more data processing activities may then be identified for execution. For example, if the identified location is with regard to the beacon device 114 as the customer is approaching the facility 102 entrance, a data processing activity may be identified and invoked to retrieve customer profile data and an image of the customer from a database and to transmit that data, via the network 118, to a point of sale (POS) terminal 112 or other facility 102 computing device located inside the facility 102 near the entrance. This data may then be presented to inform the attendant to greet the customer by name when they see the person represented in the image. Similarly, in many restaurants today, customers may order food for pickup with the food being delivered to their car when the park in the parking lot. Thus, the app on the customer's mobile device 116, 117 upon receipt of a signal from one or more of the beacon devices 122, 124, 126 located in designated parking spots in a parking lot, this data may be transmitted to the backend system 120. The backend system 120 may then identify and perform data processing activities with regard to the particular customer to identify an open pickup order for curbside delivery. The process may then inform personnel of the facility 102 that the customer has arrived, their location such as the specific parking spot, and may also provide additional details with regard to their vehicle if the vehicle is included in order or customer profile data. Facility 102 personnel may then promptly deliver the order curbside upon the customer's arrival.

Some other embodiments may also provide customer specific information to facility personnel. This information may be obtained from customer profile data stored in the backend system 120 or elsewhere with or in an associative manner with the customer account. This customer profile data may include data representative of customer preferences, such as favorite beverages, clothing sizes and color preferences, known allergies, desired hotel room amenities, medical history data (subject to any privacy laws, regulations, restrictions, policies, and customer preferences), favorite or frequented gaming machines and devices, and the like. This customer specific information may be leveraged and purposed by different data processing activities that may be invoked based on a location of the customer within the facility 102. Such data processing activities may also cause loyalty points or value to be added to the customer account and allow a customer to access a stored value account maintained by the facility 102, such as to pay for goods or services ordered, input currency or points and receive the same in return from gaming devices, and the like. In some embodiments, points may be added to the customer account when the customer is identified as being in a particular location, for entering the facility 102, for playing a certain game in a casino, and the like.

Further details of some such embodiments are described with regard to the following methods.

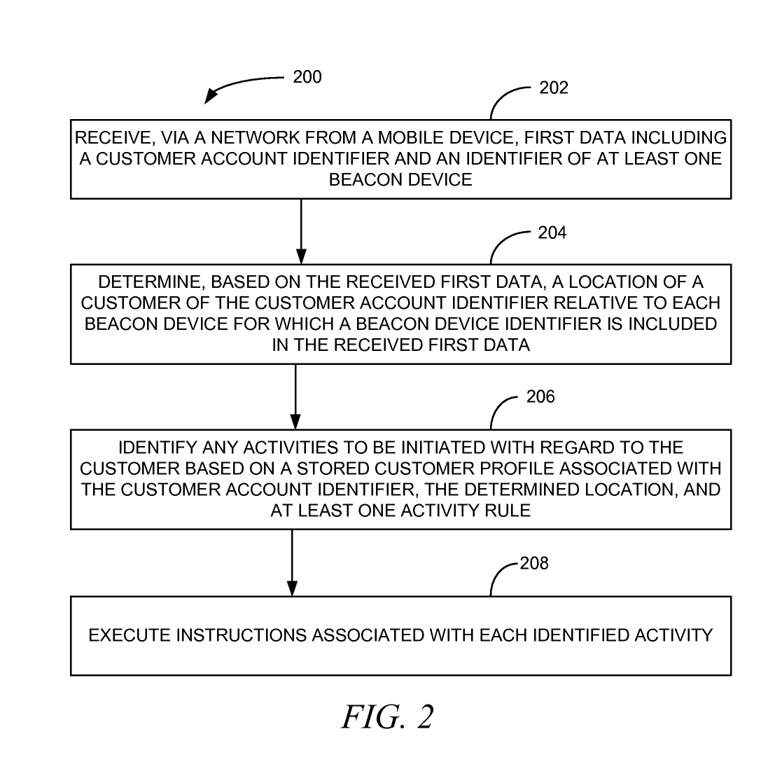

FIG. 2 is a block flow diagram of a method 200, according to an example embodiment. The method 200 is an example of method that may be performed in whole or in part in a backend system, such as backend system 120 illustrated and described above with regard to FIG. 1, upon receipt of location data and a customer account identifier from a mobile device app.

The method 200 includes receiving 202, via a network from a mobile device, first data including a customer account identifier and an identifier of at least one beacon device. The method 200 may then determine 204, based on the received data, a location of a customer of the customer account identifier relative to each beacon device for which a beacon device identifier is included in the received first data.

Based on a stored customer profile associated with the customer account identifier, the determined location, and at least one activity rule applied to the received data, the method 200 identifies 206 any activities to be initiated with regard to the customer. When any activities have been identified 206 for initiation the method 200 invokes the respective activities and executes 208 instructions associated with each identified 206 activity.

In some embodiments of the method 200, the backend system stores beacon data with regard to each of a plurality of deployed beacon devices. The beacon data in such embodiments typically includes at least data representative of a location and a beacon identifier that is broadcast by the respective beacon. This data may then be utilized by one or more backend system processes to determine locations. In some embodiments, some or a portion of the beacon data may be provided to mobile device apps to enable the mobile device apps to determine their locations.

In some embodiments of the method 200, a stored customer profile includes at least a customer account identifier, customer identifying data, and a customer status indicator for each of a plurality of customer profiles. The status indicator may be an indicator of a status level in a loyalty program, such as basic, silver, gold, platinum, and diamond, or standard, preferred, and premiere, or other status level indicators the attainment of which earns customers one or more additional services, benefits, and privileges. Thus, in such embodiments, the activity rules may include a consideration of the customer status indicator in identifying 206 whether at least one activity is to be initiated.

With further regard to activities identified 206 for initiation, in some embodiments an activity rule may determine whether the customer has a reservation or appointment for the present day. When the customer does have a reservation or appointment, a data processing activity is initiated that automatically checks the customer, such as into a hotel room, with a restaurant host, in an appointment or reservation system, and the like. In some such embodiments, the method 200 may further transmit data to a particular computing device identified based on the determined location. The additional data in such embodiments may include one or more of a portion of the customer profile data, data with regard to the checking in of the customer, and an instruction to invoke a process that executes on the computing device. The instruction may invoke a process on the computing device to cause data to be presented in a user interface on the computing device that includes at least a portion of the customer profile data and data with regard to the checking in of the customer. This data may then prompt a receptionist, host, or other personnel to greet the customer by name and direct them to a proper location, reducing if not entirely avoiding delay for the customer. In some such embodiments, such as where the customer has been checked into a hotel room, the method 200 may include transmitting key data to the customer mobile device. The key data in such embodiments may be keyed to a controlled access item associated with the reservation. For example, the key data may be a key that may be provided by the mobile device app of the customer via a transceiver device to a transceiver device of a door lock to unlock the door. The key data may also or alternatively include a WI-FI® password, a code to be entered on a door to gain access such as a fitness center or business center, and the like.

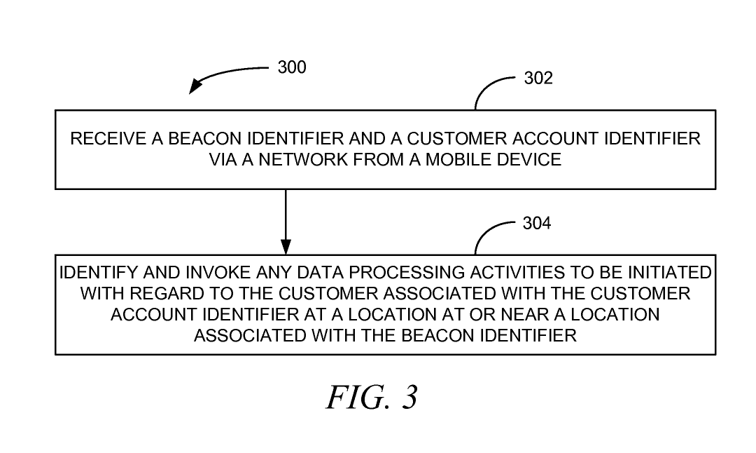

FIG. 3 is a block flow diagram of a method 300, according to an example embodiment. The method 300 is an example of another method that may be performed in whole or in part in a backend system, such as backend system 120 illustrated and described above with regard to FIG. 1, upon receipt of location data and a customer account identifier from a mobile device app.

The method 300 includes receiving 302 a beacon identifier and a customer account identifier via a network from a mobile device. The method 300 further includes identifying and invoking 304 any data processing activities to be initiated with regard to the customer associated with the customer account identifier at a location at or near a location associated with the beacon identifier.

In some of the method 300 embodiments, an identified and invoked 304 data processing activity is a greeting data processing activity. The greeting data processing activity may include retrieving customer profile data based on the customer account identifier. The greeting data processing activity typically also includes transmitting the customer profile data via a network to a computing device proximately located to a beacon device of the beacon identifier with a greeting instruction. Such a greeting instruction may invoke a presentation of the customer profile data on the computing device to assist personnel in personally greeting the customer.

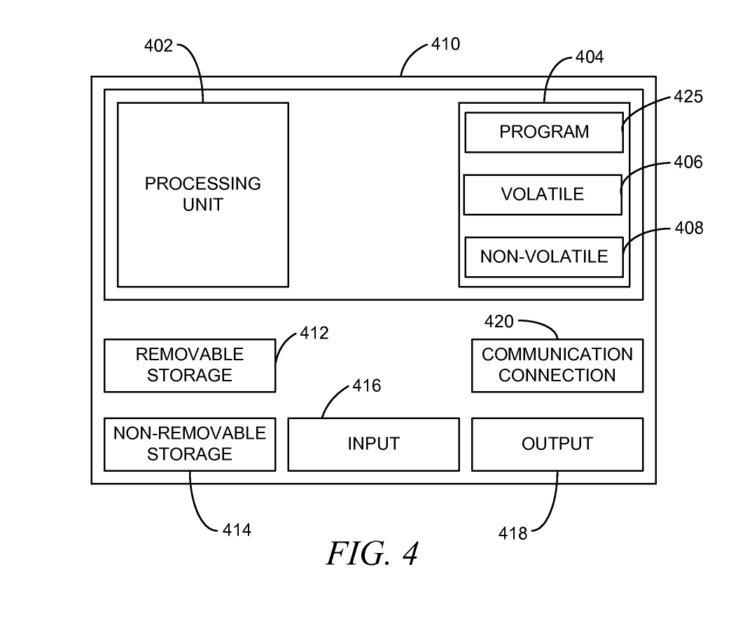

FIG. 4 is a block diagram of a computing device, according to an example embodiment. In one embodiment, multiple such computer systems are utilized in a distributed network to implement multiple components in a transaction-based environment. An object-oriented, service-oriented, or other architecture may be used to implement such functions and communicate between the multiple systems and components. One example computing device in the form of a computer 410, may include a processing unit 402, memory 404, removable storage 412, and non-removable storage 414. Although the example computing device is illustrated and described as computer 410, the computing device may be in different forms in different embodiments. For example, the computing device may instead be a smartphone, a tablet, smartwatch, or other computing device including the same or similar elements as illustrated and described with regard to FIG. 4. Devices such as smartphones, tablets, and smartwatches are generally collectively referred to as mobile devices. Further, although the various data storage elements are illustrated as part of the computer 410, the storage may also or alternatively include cloud- based storage accessible via a network, such as the Internet.

Returning to the computer 410, memory 404 may include volatile memory 406 and non-volatile memory 408. Computer 410 may include—or have access to a computing environment that includes a variety of computer-readable media, such as volatile memory 406 and non-volatile memory 408, removable storage 412 and non-removable storage 414. Computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 410 may include or have access to a computing environment that includes input 416, output 418, and a communication connection 420. The input 416 may include one or more of a touchscreen, touchpad, mouse, keyboard, camera, one or more device-specific buttons, one or more sensors integrated within or coupled via wired or wireless data connections to the computer 410, and other input devices. The computer 410 may operate in a networked environment using a communication connection 420 to connect to one or more remote computers, such as database servers, web servers, and other computing device. An example remote computer may include a personal computer (PC), server, router, network PC, a peer device or other common network node, or the like. The communication connection 420 may be a network interface device such as one or both of an Ethernet card and a wireless card or circuit that may be connected to a network. The network may include one or more of a Local Area Network (LAN), a Wide Area Network (WAN), the Internet, and other networks. In some embodiments, the communication connection 420 may also or alternatively include a transceiver device, such as a BLUETOOTH® device that enables the computer 410 to wirelessly receive data from and transmit data to other BLUETOOTH® devices.

Computer-readable instructions stored on a computer-readable medium are executable by the processing unit 402 of the computer 410. A hard drive (magnetic disk or solid state), CD-ROM, and RAM are some examples of articles including a non-transitory computer-readable medium. For example, various computer programs 425 or apps, such as one or more applications and modules implementing one or more of the methods illustrated and described herein or an app or application that executes on a mobile device or is accessible via a web browser, may be stored on a non-transitory computer-readable medium.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
receiving, via a network from a mobile device, first data including a customer account identifier and an identifier of at least one beacon device;
determining, based on the received first data, a location of a customer of the customer account identifier relative to each beacon device for which a beacon device identifier is included in the received first data;
identifying any activities to be initiated with regard to the customer based on a stored customer profile associated with the customer account identifier, the determined location, and at least one activity rule; and
executing instructions associated with each identified activity.

2. The method of claim 1, further comprising:
storing beacon data with regard to each of a plurality of deployed beacon devices, the data stored with regard to each beacon device including data representative of a location and a beacon identifier that is broadcast by the respective beacon; and
wherein the location is determined based on the stored beacon data.

3. The method of claim 1, wherein:
a stored customer profile includes a customer account identifier, customer identifying data, and a customer status indicator for each of a plurality of customer profiles;
wherein an activity rule of the at least one activity rules includes a consideration of the customer status indicator in determining whether at least one activity is to be initiated.

4. The method of claim 3, wherein activity initiated by the activity rule of the at least one activity rules is initiated when the customer status indicator is equal to a particular status and the at least one activity includes:
retrieving at least a portion of customer profile data from the stored customer profile data based at least in part on the customer account identifier; and
transmitting second data to a computing device identified based on the determined location, the second data including the retrieved customer profile data.

5. The method of claim 4, wherein the second data further includes an instruction to invoke a process that executes on the computing device to cause data to be presented in a user interface on the computing device representing a task to be performed with regard to the customer.

6. The method of claim 5, wherein:
the second data further includes an image of the customer; and
the data to be presented in the user interface of on the computing device includes the image of the customer to assist personnel in identifying and locating the customer.

7. The method of claim 1, wherein the at least one activity rule, when applied:
determines whether the customer has a reservation for the present day;
automatically checks the customer in when the customer has a reservation for the present data; and
transmits second data to a computing device identified based on the determined location, the second data including a least a portion of the customer profile data, data with regard to the checking in of the customer, and an instruction to invoke a process that executes on the computing device to cause data to be presented in a user interface on the computing device that includes at least a portion of the customer profile data and data with regard to the checking in of the customer.

8. The method of claim 7, wherein automatically checking the customer in includes:
transmitting a key data to the customer mobile device, the key data keyed to a controlled access item associated with the reservation.

9. The method of claim 8, wherein the controller access item is a door lock to which at least a portion of the key data can be provided from the mobile device to unlock the door lock.

10. The method of claim 1, wherein the at least one activity rule, when applied:
determines whether the customer has an open order; and
when the customer has an open order, transmits second data to a computing device identified based on the determined location, the second data including a least a portion of the customer profile data, data with regard to the open order, and an instruction to invoke a process that executes on the computing device to cause data to be presented in a user interface on the computing device that includes at least a portion of the customer profile data and data with regard to the open order.

11. A method comprising:
receiving a beacon identifier and a customer account identifier via a network from a mobile device;
identifying and invoking any data processing activities to be initiated with regard to the customer associated with the customer account identifier at a location at or near a location associated with the beacon identifier.

12. The method of claim 11, wherein an identified and invoked data processing activity is a greeting data processing activity, the greeting data processing activity including:
retrieving customer profile data based on the customer account identifier;
transmitting the customer profile data to a computing device proximately located to a beacon device of the beacon identifier with a greeting instruction that invokes a presentation of the customer profile data on the computing device to assist personnel in personally greeting the customer.

13. The method of claim 12, wherein the customer profile data retrieved based on the customer account identifier further includes data representative of at least one customer preference.

14. The method of claim 11, wherein:
the customer profile is associated with a point account; and
an identified and invoked data processing activity is a point crediting activity that credits at least one point to the point account associated with the customer profile.

15. The method of claim 11, wherein an identified and invoked data processing activity is a messaging activity, the execution of which causes a message to be sent to a computing device of a staff member, the message including customer profile data and an instruction to perform a task with regard to the customer.

16. A system comprising:
at least one network interface device;
at least one processor;
at least one memory; and
an instruction set, stored in memory and executable by the at least one processor to perform data processing activities, the data processing activities comprising:
receiving a beacon identifier and a customer account identifier via the at least one network interface device from a mobile device; and
identifying and invoking any additional data processing activities to be initiated with regard to the customer associated with the customer account identifier at a location at or near a location associated with the beacon identifier.

17. The system of claim 11, wherein an identified and invoked additional data processing activity is a greeting data processing activity, the greeting data processing activity including:
retrieving customer profile data from a database based on the customer account identifier;
transmitting the customer profile data, via the at least one network interface device, to a computing device proximately located to a beacon device of the beacon identifier with a greeting instruction that invokes a presentation of the customer profile data on the computing device to assist personnel in personally greeting the customer.

18. The system of claim 17, wherein the computing device is a mobile device and the customer profile data is transmitted to an app that executes on the mobile device.

19. The system of claim 17, wherein the customer profile data retrieved based on the customer account identifier further includes data representative of a clothing size preference of the customer.

20. The system of claim 16, wherein an identified and invoked data processing activity is a messaging activity, the execution of which causes a message to be sent to a computing device of a staff member, the message including customer profile data and an instruction to obtain a provide a at least one specific item to the customer.
